(19) United States
(12) Patent Application Publication
(10) Pub. No.: US 2023/0322132 A1
(43) Pub. Date: Oct. 12, 2023

(54) FIXING MEMBER FOR CONVEYANCE SEAT, CONVEYANCE SEAT, AND METHOD FOR MANUFACTURING CONVEYANCE SEAT

(71) Applicant: TS TECH CO., LTD., Asaka-shi (JP)

(72) Inventor: Peter SCHUPSKA, Reynoldsburg, OH (US)

(21) Appl. No.: 18/181,933

(22) Filed: Mar. 10, 2023

Related U.S. Application Data
(60) Provisional application No. 63/269,150, filed on Mar. 10, 2022.

(51) Int. Cl. B60N 2/30; B60N 2/015

(52) U.S. Cl. CPC B60N 2/3047; B60N 2/01541

(57) ABSTRACT

There is provided a fixing member for a conveyance seat, which allows an object to be more suitably attached than in the related art. A fixing member for a conveyance seat is a member attached to a back surface of a seat cushion and used for attaching an object to the conveyance seat. The fixing member includes a first attachment portion and a second attachment portion provided spaced apart from each other along the back surface of the seat cushion, and attached to the back surface of the seat cushion, and a connecting portion connecting the first attachment portion and the second attachment portion. A plurality of through holes for fixing the object are formed in the connecting portion.

### BACKGROUND OF THE INVENTION

### Field of the Invention

The present invention relates to a fixing member for a conveyance seat, a conveyance seat, and a method for manufacturing a conveyance seat.

### Description of the Related Art

In the related art, a conveyance seat that is switchable between a normal state for an occupant to be seated and a moved state where a seat cushion is flipped up from the normal state has been known (for example, refer to U.S. Patent Application Publication No. 2017/0282809 Specification (Document '809)).

The conveyance seat described in Document '809 includes a fixing member attached to a back surface of the seat cushion and used for attaching an object (object to be hooked) to the conveyance seat.

The object can be hooked onto the conveyance seat by using the fixing member.

By the way, in the conveyance seat described above, devising a configuration and disposition of the fixing member is required to suitably attach an object to the conveyance seat.

### SUMMARY OF THE INVENTION

An object of the present invention is to provide a fixing member for a conveyance seat, a conveyance seat, and a method for manufacturing a conveyance seat, which allow an object to be more suitably attached than in the related art.

The foregoing problem is solved by providing a fixing member attached to a back surface of a seat cushion of a conveyance seat and used for attaching an object to the conveyance seat, the member including: a first attachment portion and a second attachment portion provided spaced apart from each other along the back surface of the seat cushion, and attached to the back surface of the seat cushion; and a connecting portion connecting the first attachment portion and the second attachment portion. A plurality of through holes for fixing the object are formed in the connecting portion.

With this configuration, it is possible to realize the fixing member for a conveyance seat, which allows the object to be more suitably attached than in the related art.

In addition, the foregoing problem is also solved by a conveyance seat including a fixing member for a conveyance seat and by a method for manufacturing a conveyance seat.

### BRIEF DESCRIPTION OF THE DRAWINGS

FIG. 1 is a perspective view of a conveyance seat of a first embodiment, and is a view showing a “normal state”.

FIG. 2 is a perspective view of the conveyance seat, and is a view showing a “tip-up state (moved state)”.

FIG. 3 is a perspective view of seat frames, support legs, and cushion covers.

FIG. 4 is an exploded perspective view of a cushion frame and the cushion cover.

FIG. 5 is an exploded cross-sectional view of the cushion frame, the cushion cover, and a fixing member taken along line V-V in FIG. 3.

FIG. 6 is a cross-sectional view of the cushion frame, the cushion cover, and the fixing member.

FIG. 7 is a perspective view of a fixing member of a first embodiment.

FIG. 8 is a front view of the fixing member.

FIG. 9 is a top view of the fixing member.

FIG. 10 is a perspective view of a fixing member of a second embodiment.

FIG. 11 is a perspective view of a fixing member of a third embodiment.

FIG. 12 is a perspective view of a fixing member of a fourth embodiment.

FIG. 13 is a side view of a conveyance seat of a second embodiment, and is a view showing a “normal state”.

FIG. 14 is a side view of the conveyance seat, and is a view showing a “tip-up state”.

FIG. 15 is a perspective view of a conveyance seat of a third embodiment, and is a view showing a “tip-up state”.

FIG. 16 is an exploded perspective view of a cushion frame and a cushion cover.

FIG. 17 is a top view of the cushion frame, the cushion cover, and a fixing member.

### DESCRIPTION OF THE PREFERRED EMBODIMENTS

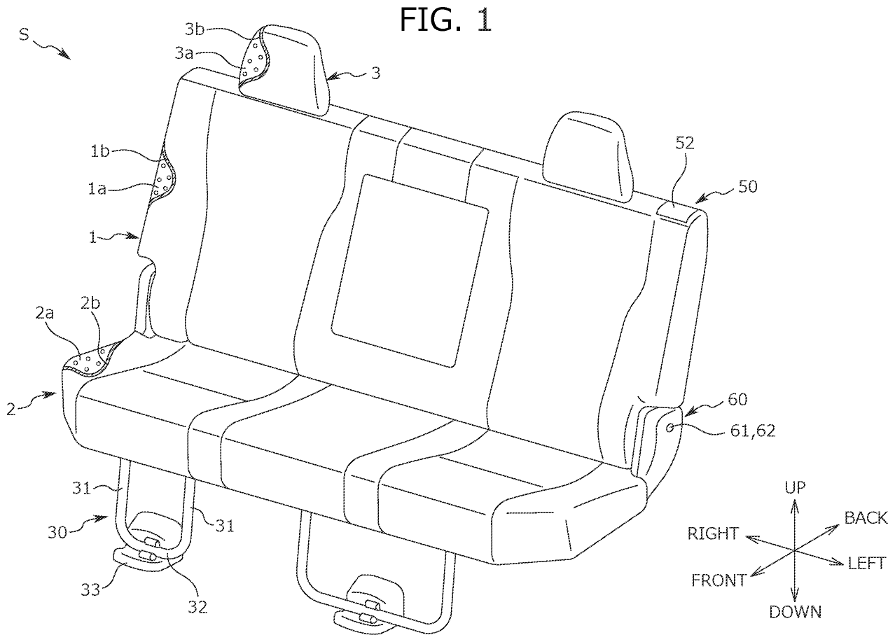

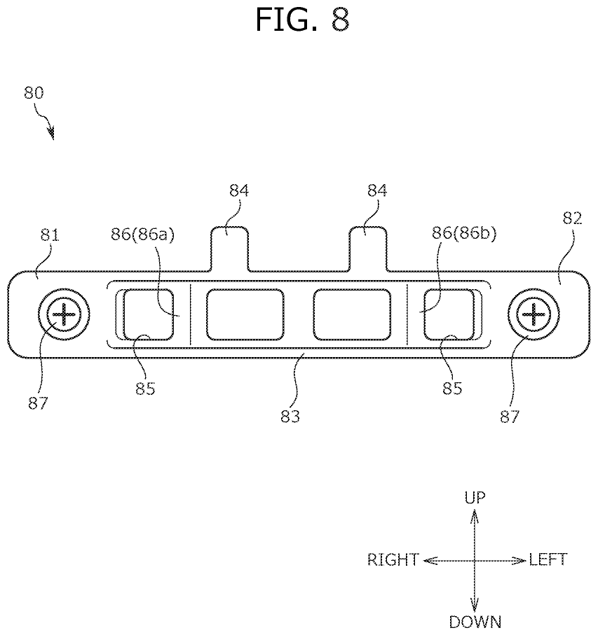

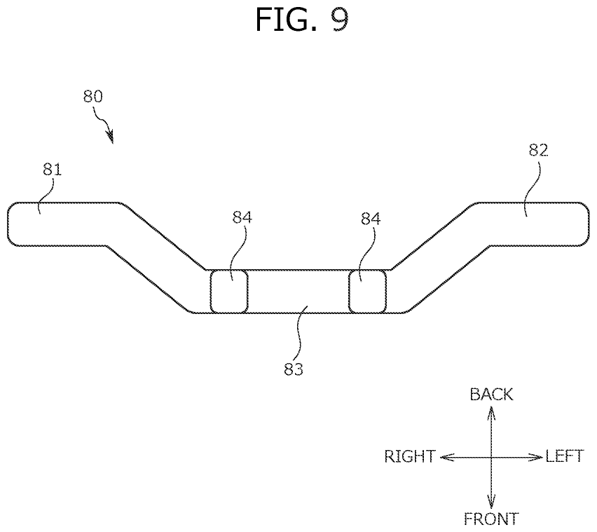

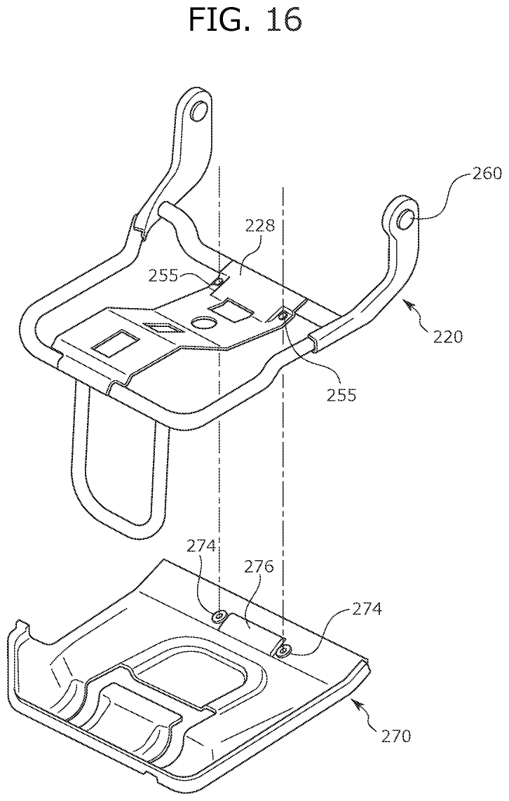

Hereinbelow, embodiments will be described with reference to FIGS. 1 to 17.

The present embodiment relates to a fixing member for a conveyance seat (fixing member), a conveyance seat, and a method for manufacturing a conveyance seat.

Incidentally, a side of a seat back (headrest) of the conveyance seat, on which a seated occupant is seated, becomes a seat front side.

<First Embodiment of Conveyance Seat>

As shown in FIG. 1, a conveyance seat S is a rear seat corresponding to, for example, a rear seat of a vehicle. Incidentally, the conveyance seat S can also be used as a second-row middle seat in a vehicle including three rows of seats in a vehicle front to back direction.

The conveyance seat S is a seat that can be in three types of seat arrangement modes: a “normal state” for an occupant to be seated, a “stored state” where a seat body is stored in a conveyance floor, and a “tip-up state” where the seat body (seat cushion) is flipped upward.

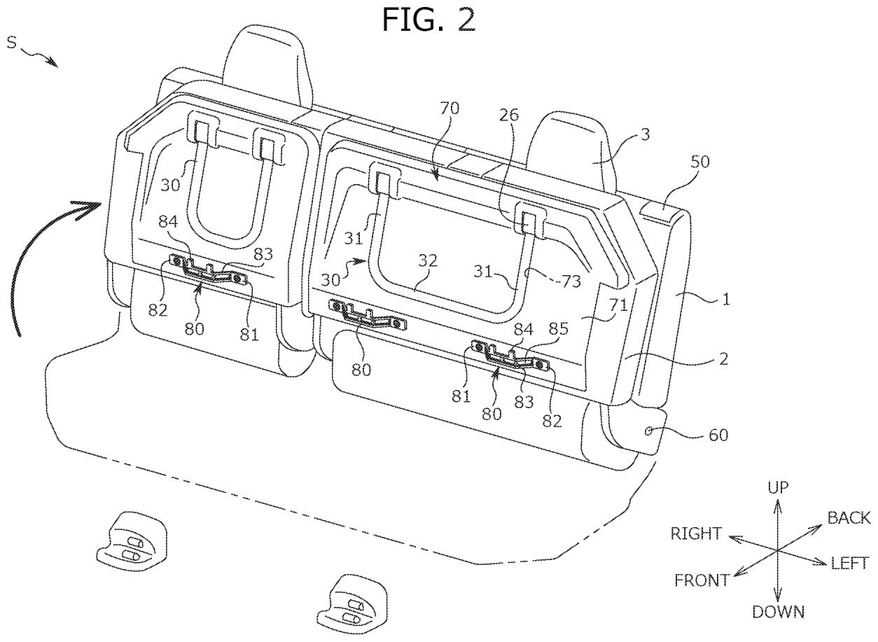

Specifically, when the occupant operates a back operating lever 52 located at an upper end portion of the seat body, the conveyance seat S is switched from the “normal state” shown in FIG. 1 to the “stored state” (not shown) in which the seat body is tilted forward, is folded, and is stored in the conveyance floor. Then, when the occupant manually raises the seat body upward, the conveyance seat S is switched from the “stored state” to the “tip-up state” shown in FIG. 2. Further, when the occupant operates a cushion operating lever located at a front end portion of the seat body (seat cushion), a part of the seat body (seat cushion) rotates downward, and the conveyance seat S returns to the “normal state” shown in FIG. 1 from the “tip-up state”.

Incidentally, when the occupant operates the cushion operating lever, the conveyance seat S is also switchable from the “normal state” shown in FIG. 1 to the “tip-up state”.

As shown in FIGS. 1 to 3, the conveyance seat S includes the seat body including a seat back 1, a seat cushion 2, and a headrest 3; a support leg 30 attached between the seat cushion 2 and the conveyance floor, and supporting the seat cushion 2; a support base 40 that rotatably supports the seat back 1; a switching device 50 that rotatably connects the seat back 1 to the support base 40; and a cushion lock device 60 that rotatably connects the seat cushion 2 to the seat back 1.

In addition, as shown in FIG. 1, the conveyance seat S further includes a cushion cover 70 attached to a back surface of the seat cushion 2 and covering the seat cushion 2 from below, and a fixing member 80 attached to back surfaces of the seat cushion 2 and the cushion cover 70 and used for attaching an object (object to be hooked) to the conveyance seat S.

As shown in FIGS. 1 to 3, the seat back 1 includes a back frame 10 that is a backrest portion supporting the occupant from behind and that serves as a skeleton, a pad material 1a placed on the back frame 10, and a skin material 1b covering the back frame 10 and the pad material 1a.

The seat cushion 2 includes a cushion frame 20 that is a seating portion supporting the occupant from below and that serves as a skeleton, a pad material 2a placed on the cushion frame 20, and a skin material 2b covering the cushion frame 20 and the pad material 2a.

The headrest 3 includes a pillar that is a head portion supporting the occupant's head from behind and that serves as a core material, a pad material 3a placed on the pillar, and a skin material 3b covering the pillar and the pad material 3a.

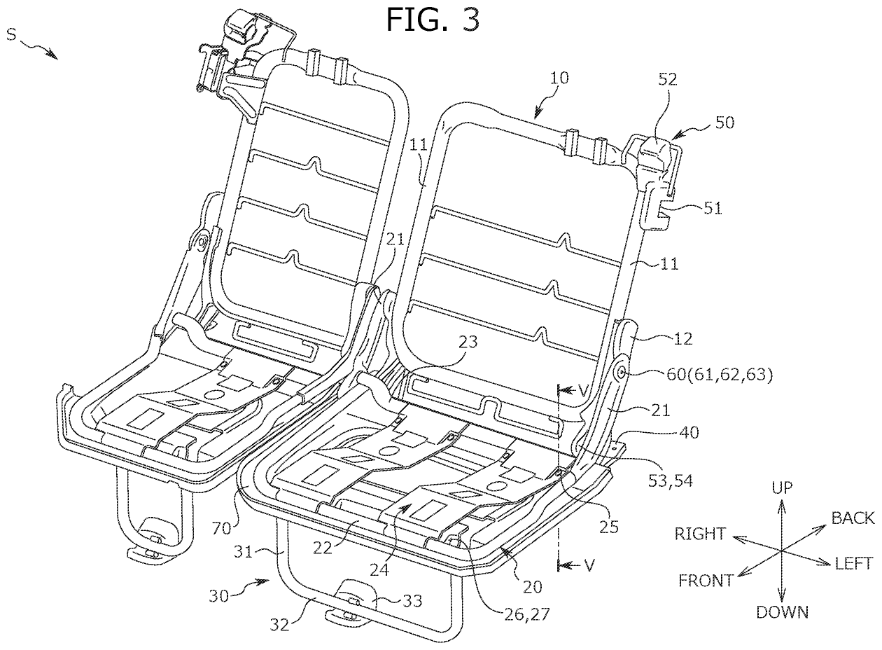

As shown in FIG. 3, the back frame 10 is a rectangular frame-shaped body serving as the skeleton of the seat back 1. Right and left connecting brackets 12 for connecting to the support base 40 are attached to lower portions of right and left back side frames 11 forming side portions of the back frame 10.

The connecting brackets 12 are bow-shaped sheet material members extending in an up to down direction. Upper end portions of the connecting brackets 12 are attached to an outer surface of the back frame 10 (back side frames 11), and lower end portions of the connecting brackets 12 are attached to an inner surface of the support base 40.

A back rotating shaft 53 (switching device 50) that rotatably connects the back frame 10 to the support base 40 is attached to the lower end portions of the connecting brackets 12.

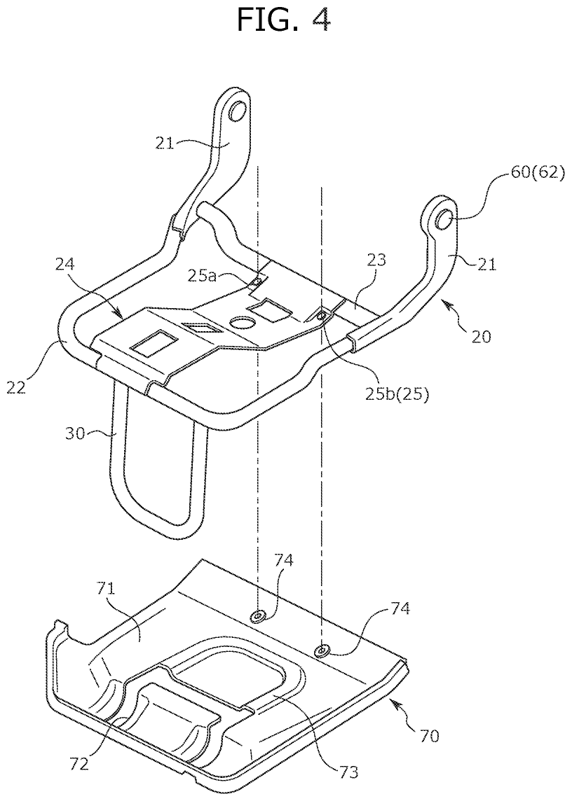

As shown in FIGS. 3 and 4, the cushion frame 20 is a rectangular frame-shaped body serving as the skeleton of the seat cushion 2.

The cushion frame 20 includes right and left side frames 21 disposed on lateral sides in a seat width direction, a front frame 22 connecting front portions of each of the side frames 21, a rear frame 23 connecting rear portions of each of the side frames 21, and a pan frame 24 as a plate-shaped frame connecting the front frame 22 and the rear frame 23.

The cushion lock device 60 is attached to rear end portions of the right and left side frames 21. In addition, a leg lock device 26, which connects the support leg 30 to the cushion frame 20 so as to be rotatable around a leg rotating shaft 27 as the center, is attached to the front frame 22.

As shown in FIGS. 1 to 4, the support leg 30 is a U-shaped pipe member supporting the seat cushion 2.

The support leg 30 includes leg body portions 31 disposed on right and left lateral sides, and a leg connecting portion 32 connecting lower end portions of each of the leg body portions 31.

Upper end portions of the leg body portions 31 are connected to an inner surface of the cushion frame 20 via the leg lock device 26 (leg rotating shaft 27). In addition, a central portion in the seat width direction of the leg connecting portion 32 is detachably held by a leg holding member 33 located on the conveyance floor.

In the “normal state” shown in FIG. 1, the support leg 30 is deployed downward from the seat cushion 2, and is held by the leg holding member 33.

In addition, in the “tip-up state” shown in FIG. 2, the support leg 30 is folded to a seat cushion 2 side, and is accommodated in a leg accommodation portion 73 formed in the cushion cover 70.

Incidentally, the support leg 30 is assembled by penetrating through the cushion cover 70.

As shown in FIG. 3, the support base 40 is a member supporting the seat back 1, and is an L-shaped sheet material member that is long in a seat front to back direction.

The support base 40 is disposed on a lateral side in the seat width direction, and is connected to the conveyance floor.

As shown in FIGS. 1 to 3, the switching device 50 is a device that switches the conveyance seat S from the “normal state” to the “stored state”, and is attached to an upper portion of the back frame 10.

The switching device 50 includes an engagement hook 51 provided to be detachable from an engagement striker that is a part of a conveyance body, the back operating lever 52 for moving the engagement hook 51 in a seat up to down direction and locking the engagement hook 51 to the engagement striker, the back rotating shaft 53, and a spiral spring 54 that biases the back frame 10 so as to be rotated forward around the back rotating shaft 53 as the center.

The engagement hook 51 is connected to the back operating lever 52 via a cable (not shown), and is configured to be switchable between a “lockable state” where the engagement hook 51 is lockable to the engagement striker by the back operating lever 52 and an “unlockable state” where the engagement hook 51 is unlockable.

As shown in FIGS. 1 to 3, the cushion lock device 60 is disposed on an outer surface of the side frame 21 in the seat width direction.

The cushion lock device 60 includes a lock body 61 that locks the rotation operation of the cushion frame 20, a cushion rotating shaft 62, a spiral spring 63 that biases the cushion frame 20 downward around the cushion rotating shaft 62 as the center, and the cushion operating lever that is operated to release a lock state of the cushion frame 20.

The cushion lock device 60 can lock the cushion frame 20 in a horizontal posture shown in FIG. 3, release the lock state in conjunction with the back frame 10 when the back operating lever 52 is operated, and fold the cushion frame 20 to a conveyance floor side while biasing the cushion frame 20 downward using a biasing force of the spiral spring 63.

In addition, when the cushion operating lever is operated in the “normal state”, the cushion lock device 60 can release the lock state of the cushion frame 20, and raise the cushion frame 20 upward against the biasing force of the spiral spring 63 to move the cushion frame 20 to the “tip-up state” shown in FIG. 2. Then, when the cushion operating lever is operated again in the “tip-up state”, the cushion frame 20 can be rotated downward by the biasing force of the spiral spring 63 to return to the “normal state” shown in FIGS. 1 and 3.

As shown in FIGS. 2 to 4, the cushion cover 70 is a resin-molded product attached to the back surface of the seat cushion 2 (cushion frame 20) and covering the seat cushion 2.

The cushion cover 70 includes a cover body 71 corresponding to the external shape of the cushion frame 20, a leg insertion hole 72 which is formed in a front portion of the cover body 71 and into which the support leg 30 is inserted, the leg accommodation portion 73 that is formed in a central portion of the cover body 71 and that accommodates the support leg 30, and an attachment portion 74 that is formed in a rear portion of the cover body 71 and that is assembled to the cushion frame 20.

The attachment portion 74 is a portion in which the cushion frame 20 and the fixing member 80 are assembled.

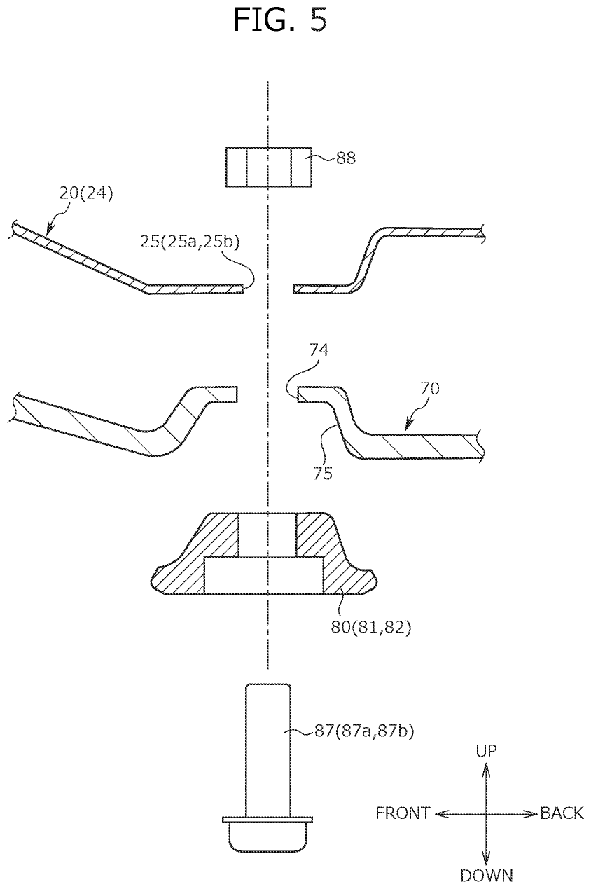

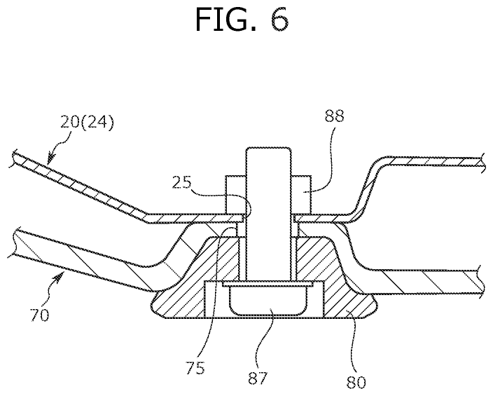

As shown in FIGS. 5 and 6, the attachment portion 74 is an attachment hole, and is disposed at a position facing an attached portion 25 (attachment hole) of the pan frame 24.

In more detail, by attaching an attachment bolt 87 and an attachment nut 88 in a state where the attachment portion 74 and the attached portion 25 are in communication with each other, the cushion frame 20 (pan frame 24), the cushion cover 70, and the fixing member 80 are assembled together.

Incidentally, as shown in FIGS. 5 and 6, an accommodation recess 75 that accommodates the fixing member 80 (attachment portions 81 and 82) is formed in a portion of the cushion cover 70, in which the attachment portion 74 is formed, and in a portion therearound. For this reason, the fixing member 80 can be compactly disposed.

<<First Embodiment of Fixing Member>>

As shown in FIG. 2, the fixing member 80 is a fixing body (fixing grip) for attaching an object to the conveyance seat S when the conveyance seat S is in the “tip-up state”.

By using the fixing member 80, luggage can be fixed to the conveyance seat S in the conveyance or luggage can be hooked. For example, luggage (relatively large luggage) such as bicycle, motorcycle, and leisure goods can be fixed or hooked.

As shown in FIGS. 2 and 6 to 9, the fixing member 80 includes the first attachment portion 81 and the second attachment portion 82 provided spaced apart from each other in the seat width direction, and attached to the back surface of the seat cushion 2; a connecting portion 83 connecting the first attachment portion 81 and the second attachment portion 82; and a hook portion 84 attached to an upper end portion of the connecting portion 83.

A plurality of through holes 85 for fixing an object are formed in the connecting portion 83. The through holes 85 are formed to penetrate through the connecting portion 83.

In addition, a plurality of reinforcement portions 86 extending across the connecting portion 83 are formed in portions of the connecting portion 83, in which the through holes 85 are formed. For this reason, the fixing member 80 can be reinforced while reducing the weight by forming the through holes 85.

Each of the first attachment portion 81 and the second attachment portion 82 is an attachment hole and is disposed at a position facing the attachment portion 74 of the cushion cover 70 and the attached portion 25 of the cushion frame 20.

In more detail, by attaching the attachment bolt 87 and the attachment nut 88 in a state where the first attachment portion 81 (second attachment portion 82), the attachment portion 74, and the attached portion 25 are in communication with each other, the cushion cover 70 and the fixing member 80 are assembled to the cushion frame 20.

Incidentally, a stepped portion 81a (82a) that accommodates a head portion of the attachment bolt 87 is formed in a portion around a portion of the fixing member 80, in which the first attachment portion 81 (second attachment portion 82) is formed. For this reason, the fixing member 80 can be compactly disposed.

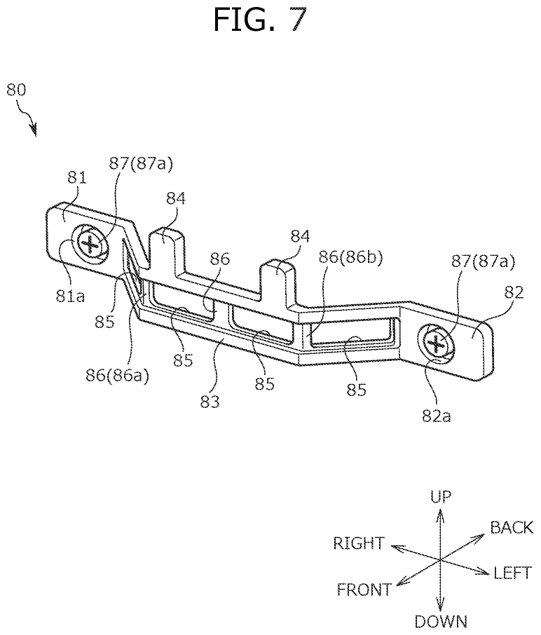

As shown in FIGS. 7 to 9, the connecting portion 83 is disposed at a position where the connecting portion 83 linearly connects the first attachment portion 81 and the second attachment portion 82. For this reason, the connecting portion 83 can be compactly disposed.

As shown in FIGS. 7 to 9, the hook portion 84 is a portion onto which an object is hooked, and is disposed between the first attachment portion 81 and the second attachment portion 82. For this reason, the hook portion 84 can be compactly disposed.

A plurality of the hook portions 84 are provided on the upper end portion of the connecting portion 83, and are disposed spaced apart from each other in an extending direction of the connecting portion 83. For this reason, a plurality of luggage can be hooked. In addition, the rotation of one luggage can be suppressed by hooking the one luggage on the plurality of hook portions 84.

The hook portions 84 are disposed at positions not overlapping the reinforcement portions 86 in the extending direction of the connecting portion 83. For this reason, when luggage hooked on the hook portions 84 is removed, the fingers can be prevented from being caught on the reinforcement portions 86.

The hook portions 84 are provided on the connecting portion 83, and are disposed at positions separated from the back surface of the seat cushion 2 (cushion cover 70). For this reason, it becomes easier to visually confirm the hook portions 84.

Each of the hook portion 84 and the reinforcement portions 86 extends in a direction orthogonal to the extending direction of the connecting portion 83, and extends in the same direction. For this reason, the fixing member 80 can be compactly designed.

A central portion in the extending direction of the connecting portion 83 is disposed at a position separated farthest from the back surface of the seat cushion 2 (cushion cover 70). Furthermore, the hook portions 84 are disposed on the central portion of the connecting portion 83. For this reason, it becomes easier to hook luggage onto the hook portions.

As shown in FIGS. 7 to 9, the through holes 85 are portions for fixing an object using a string material or the like, and are disposed between the first attachment portion 81 and the second attachment portion 82. By implementing such a configuration, the through holes 85 can be compactly disposed.

As shown in FIGS. 7 to 9, the reinforcement portions 86 are provided in the connecting portion 83, and are disposed at positions separated from the back surface of the seat cushion 2. For this reason, the rigidity of the fixing member 80 located at a position separated from the seat cushion 2 can be increased.

The reinforcement portion 86 is disposed at a position interposed between the plurality of hook portions 84 in the extending direction of the connecting portion 83. For this reason, when luggage hooked on the hook portion 84 swings, a load applied to the fixing member 80 can be received by the reinforcement portions 86.

In this configuration, the fixing member 80 has a color different from that of a portion of the back surfaces of the seat cushion 2 and the cushion cover 70, the fixing member 80 being attached to the portion.

By implementing such a configuration, it becomes easier to visually confirm the fixing member 80.

In this configuration, as shown in FIG. 2, a part of the fixing member 80 or the entirety of the fixing member 80 is disposed at a position overlapping the support leg 30 in the seat width direction.

In addition, a part or the entirety of the hook portion 84 is disposed at a position overlapping the support leg 30 in the seat width direction.

By implementing such a configuration, the support leg 30 and the fixing member 80 (hook portions 84) can be compactly disposed in the seat width direction.

In this configuration, as shown in FIGS. 4 to 7, the fixing member 80 includes a first attachment bolt 87a for attaching the first attachment portion 81 to the cushion frame 20 (first attached portion 25a), and a second attachment bolt 87b for attaching the second attachment portion 82 to the cushion frame 20 (second attached portion 25b).

As shown in FIGS. 2 and 7, the first attachment bolt 87a is disposed inside the second attachment bolt 87b and is disposed at a position overlapping the support leg 30, in the seat width direction.

The second attachment bolt 87b is disposed at a position not overlapping the support leg 30 in the seat width direction.

By implementing such a configuration, the fixing member 80 can be attached to the back surface of the seat cushion 2 over a wide range.

In this configuration, as shown in FIGS. 7 to 9, the reinforcement portions 86 include a first reinforcement portion 86a and a second reinforcement portion 86b extending across the connecting portion 83.

The first reinforcement portion 86a is disposed between the central portion of the connecting portion 83 and the first attachment portion 81. The second reinforcement portion 86b is disposed between the central portion of the connecting portion 83 and the second attachment portion 82.

By implementing such a configuration, the rigidity of the fixing member 80 can be efficiently increased.

In this configuration, as shown in FIG. 2, the central portion in the extending direction of the connecting portion 83 is disposed at the position separated farthest from the back surface of the seat cushion 2 (cushion cover 70). Furthermore, the central portion of the connecting portion 83 and the support leg 30 are disposed at the same position in the seat width direction.

By implementing such a configuration, the protrusion-shaped components (the support leg 30 and the fixing member 80) attached to the seat cushion 2 can be collectively disposed in one place.

With this configuration, it is possible to realize the fixing member 80 and the conveyance seat S to which an object can be more suitably attached than in the related art.

<<Second Embodiment of Fixing Member>>

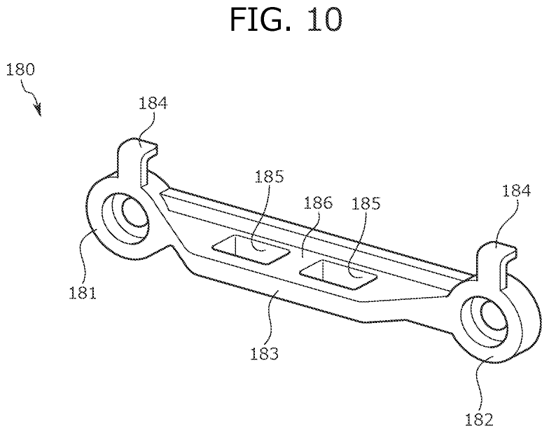

Next, a fixing member 180 of a second embodiment will be described with reference to FIG. 10.

Incidentally, the description of contents that overlap with the fixing member 80 of the first embodiment will be omitted as appropriate.

The fixing member 180 is a fixing body (fixing grip), and includes a first attachment portion 181 and a second attachment portion 182 attached to the back surface of the seat cushion 2; a connecting portion 183; and a hook portion 184.

A plurality of through holes 185 for fixing an object are formed in an upper surface of the connecting portion 183. The through holes 185 penetrate through the connecting portion 183.

In addition, a reinforcement portion 186 extending across the connecting portion 183 is formed in a portion of the connecting portion 183, in which the through holes 185 are formed.

A pair of the hook portions 184 are disposed spaced apart from each other in an extending direction of the connecting portion 183. The hook portions 184 each protrude upward from upper surfaces of the first attachment portion 181 and the second attachment portion 182.

The reinforcement portion 186 is disposed at a central portion in the extending direction of the connecting portion 183, and extends in a direction orthogonal (seat front to back direction) to a protruding direction (up to down direction) of the hook portions 184.

<<Third Embodiment of Fixing Member>>

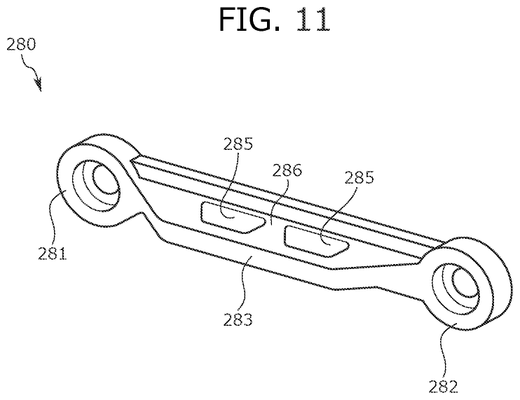

Next, a fixing member 280 of a third embodiment will be described with reference to FIG. 11.

Incidentally, the description of contents that overlap with the fixing member 80 of the first embodiment will be omitted as appropriate.

The fixing member 280 is a fixing body (fixing grip), and includes a first attachment portion 281, a second attachment portion 282, and a connecting portion 283.

A plurality of through holes 285 for fixing an object are formed in an upper surface of the connecting portion 283. The through holes 285 penetrate through the connecting portion 283.

In addition, a reinforcement portion 286 extending across the connecting portion 283 is formed in a portion of the connecting portion 283, in which the through holes 285 are formed.

Incidentally, an object can be fixed or an object can be hooked using the through holes 285 without providing hook portions.

The reinforcement portion 286 is disposed at a central portion in an extending direction of the connecting portion 283, and extends in a direction orthogonal (up to down direction) to an attachment direction (seat front to back direction) of the attachment portions 281 and 282.

<<Fourth Embodiment of Fixing Member>>

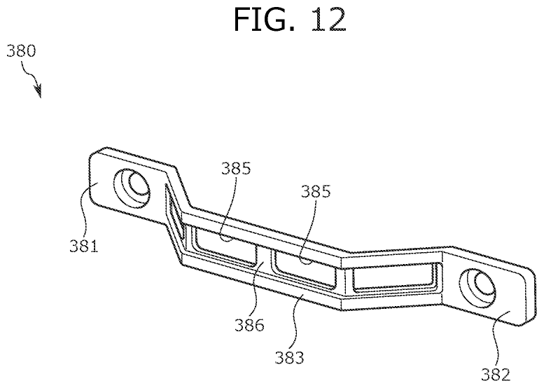

Next, a fixing member 380 of a fourth embodiment will be described with reference to FIG. 12.

Incidentally, the description of contents that overlap with the fixing member 80 of the first embodiment will be omitted as appropriate.

The fixing member 380 is a fixing body (fixing grip), and includes a first attachment portion 381, a second attachment portion 382, and a connecting portion 383.

A plurality of through holes 385 for fixing an object are formed in a front surface of the connecting portion 383.

The through holes 385 penetrate through the connecting portion 383.

In addition, a plurality of reinforcement portions 386 extending across the connecting portion 383 are formed in portions of the connecting portion 383, in which the through holes 385 are formed.

Incidentally, an object can be fixed or an object can be hooked using the through holes 385 without providing hook portions.

The plurality of reinforcement portions 386 are disposed spaced apart from each other in an extending direction of the connecting portion 383, and extend in a direction orthogonal (up to down direction) to an attachment direction (seat front to back direction) of the attachment portions 381 and 382.

<Second Embodiment of Conveyance Seat>

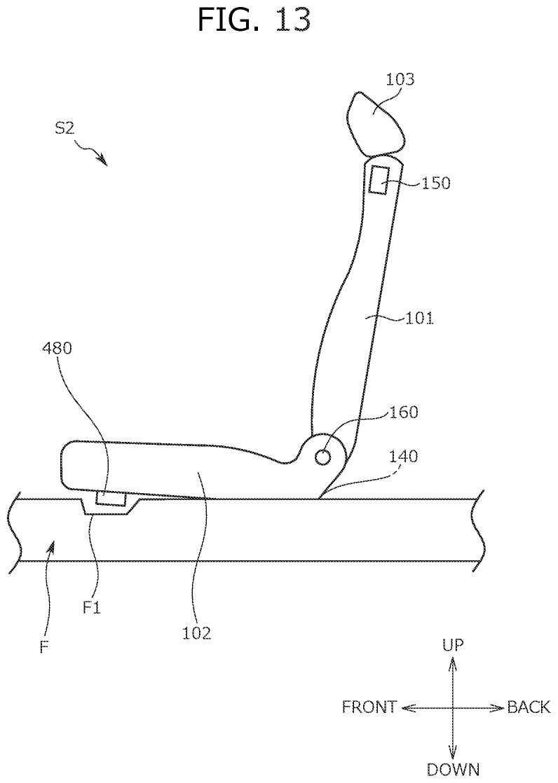

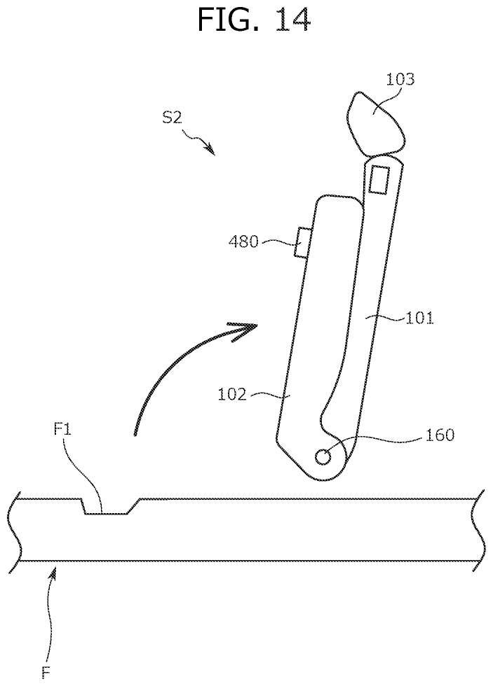

Next, a conveyance seat S2 of a second embodiment will be described with reference to FIGS. 13 and 14.

Incidentally, the description of contents that overlap with the conveyance seat S of the first embodiment will be omitted as appropriate.

The conveyance seat S2 is a seat that can be arranged in a “normal state” for an occupant to be seated, and a “tip-up state” where a seat body (seat cushion 102) is flipped upward.

The conveyance seat S2 includes the seat body including a seat back 101, a seat cushion 102, and a headrest 103; a support base 140 supporting the seat body from below; a switching device 150 that rotatably connects the seat back 101 to the support base 140; and a cushion lock device 160 that rotatably connects the seat cushion 102 to the seat back 101.

In addition, the conveyance seat S2 further includes a fixing member 480 attached to a back surface of the seat cushion 102 and used for attaching an object to the conveyance seat S2.

The support base 140 is fixed on a conveyance floor F.

The fixing member 480 is disposed on a front portion of the back surface of the seat cushion 102.

When the conveyance seat S2 is in the “normal state” shown in FIG. 13, the fixing member 480 is accommodated in an accommodation recess F1 provided in the conveyance floor F.

With this configuration, even when the conveyance seat S2 does not include a support leg, the fixing member 480 can be prevented from coming into contact with the conveyance floor F. In addition, the fixing member 480 can be suitably attached.

<Third Embodiment of Conveyance Seat>

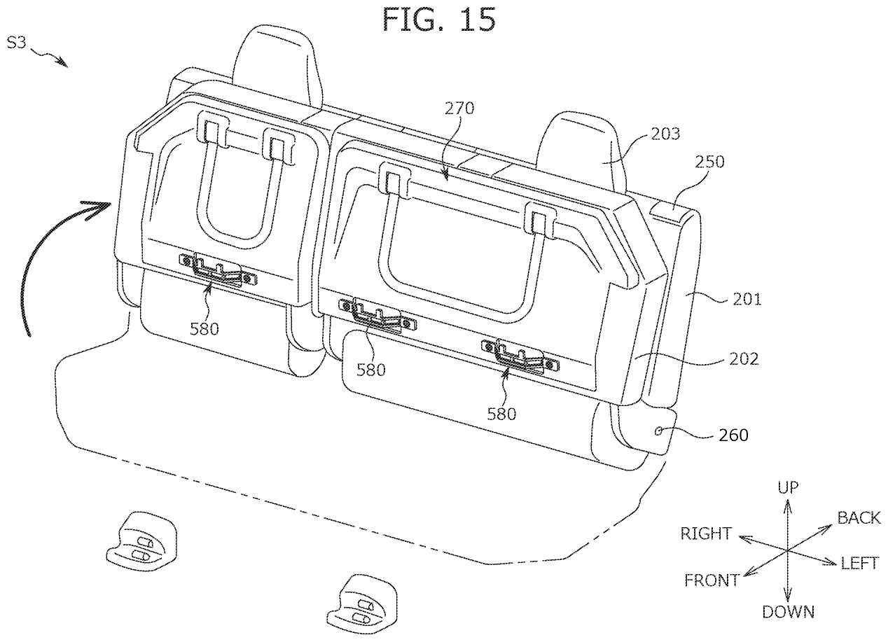

Next, a conveyance seat S3 of a third embodiment will be described with reference to FIGS. 15 to 17.

Incidentally, the description of contents that overlap with the conveyance seat S of the first embodiment will be omitted as appropriate.

The conveyance seat S3 is a seat that can be arranged in a “normal state” and a “tip-up state” shown in FIG. 15.

The conveyance seat S3 includes a seat body including a seat back 201, a seat cushion 202, and a headrest 203; a switching device 250; and a cushion lock device 260.

In addition, the conveyance seat S3 further includes a cushion cover 270 attached to a back surface of the seat cushion 202 and covering the seat cushion 202, and a fixing member 580 attached to the back surface of the seat cushion 202 and used for attaching an object.

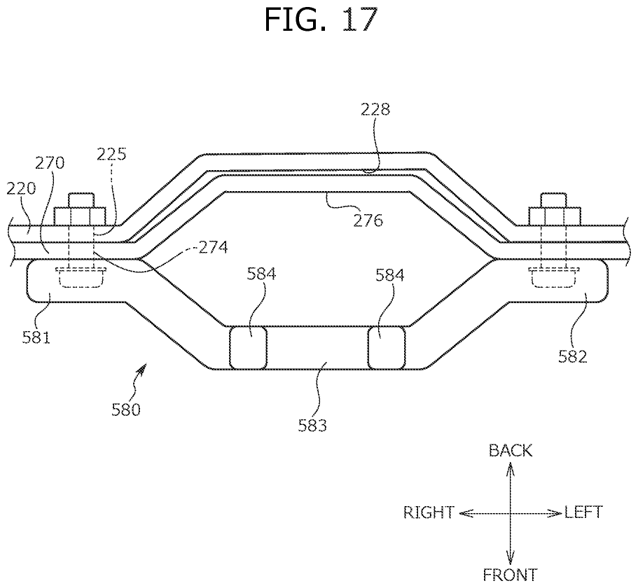

As shown in FIG. 17, the fixing member 580 includes a first attachment portion 581 and a second attachment portion 582, a connecting portion 583 connecting the first attachment portion 581 and the second attachment portion 582, and a hook portion 584 attached to an upper end portion of the connecting portion 583.

The fixing member 580 (attached portions 581 and 582) is fastened together with the cushion cover 270 (attachment portion 274) and a cushion frame 220 (attached portion 225). Incidentally, the fixing member 580 may be fastened only to the cushion frame 220.

As shown in FIGS. 15 to 17, a relief portion 228 (relief recess) is formed on a back surface of the cushion frame 220, at a position facing the fixing member 580 (connecting portion 583).

In addition, a relief portion 276 (relief recess) is formed on a back surface of the cushion cover 270 at a position facing the fixing member 580 (connecting portion 583).

By implementing such a configuration, it becomes easier to hook an object onto the fixing member 580. In addition, even when the protrusion amount of the connecting portion 583 is suppressed, it becomes easier to hook an object.

Incidentally, the relief portion 276 of the cushion cover 270 is disposed spaced apart from each other from the cushion frame 220 without interfering with the cushion frame 220. For this reason, the influence on the cushion frame 220 can be suppressed.

In addition, in order to suppress the protrusion amount of the fixing member 580 (connecting portion 583), a part of the fixing member 580 may enter the inside of the seat cushion 202 (the cushion frame 220 and the cushion cover 270). Alternatively, a part of the fixing member 580 may be in-molded into the seat cushion 202.

### OTHER EMBODIMENTS

In the above embodiment, as shown in FIG. 2, the fixing member 80 is attached to the back surface of the seat cushion 2 (cushion cover 70), but is not particularly limited thereto.

For example, the fixing member 80 may be attached to a back surface of the seat back 1 (back cover), or may be attached to a back surface of the headrest 3 (headrest cover).

In the above embodiments, the conveyance seat used in automobiles has been described as a specific example, but is not particularly limited thereto, and can be used as a conveyance seat for airplanes, ships, and the like in addition to a conveyance seat for trains, buses, and the like.

In the above embodiments, the fixing member for a conveyance seat and the conveyance seat have been described, but the invention may be related to a method for manufacturing a conveyance seat.

Specifically, the method may be a method for manufacturing a conveyance seat including a seat cushion and a fixing member provided on a back surface of the seat cushion and used for attaching an object to the conveyance seat, the method including: preparing the fixing member including a first attachment portion, a second attachment portion, and a connecting portion connecting the first attachment portion and the second attachment portion; attaching the first attachment portion to the back surface of the seat cushion; and attaching the second attachment portion to the back surface of the seat cushion at a position spaced apart from the first attachment portion, and disposing a plurality of through holes formed in the connecting portion, to be spaced apart from the back surface of the seat cushion.

By implementing this configuration, it is possible to realize the method for manufacturing a conveyance seat, which allows an object to be more suitably attached than in the related art.

In the present embodiments, the fixing member for a conveyance seat, the conveyance seat, and the method for manufacturing a conveyance seat according to the present invention have been mainly described.

However, the above embodiments are merely examples for facilitating understanding of the present invention, and do not limit the present invention. The present invention can be modified and improved without departing from the concept of the present invention, and it goes without saying that the present invention includes its equivalents.

### REFERENCE SIGNS LIST

S, S2, S3 Conveyance seat (vehicle seat)
1, 101, 201 Seat back
   1a, 2a, 3a Pad material
   1b, 2b, 3b Skin material
2, 102, 202 Seat cushion
3, 103, 203 Headrest
10 Back frame
11 Back side frame
12 Connecting bracket
20, 220 Cushion frame
21 Side frame
22 Front frame
23 Rear frame
24 Pan frame
25, 225 Attached portion (attachment hole)
   25a First attached portion
   25b Second attached portion
26 Leg lock device
27 Leg rotating shaft
228 Relief portion (relief recess)
30 Support leg
31 Leg body portion
32 Leg connecting portion
33 Leg holding member
40, 140 Support base
50, 150, 250 Switching device
51 Engagement hook
52 Back operating lever
53 Back rotating shaft
54 Spiral spring
60, 160, 260 Cushion lock device
61 Lock body
62 Cushion rotating shaft
63 Spiral spring
70, 270 Cushion cover
71 Cover body
72 Leg insertion hole
73 Leg accommodation portion
74, 274 Attachment portion (attachment hole)
75 Accommodation recess
276 Relief portion (relief recess)
80, 180, 280, 380, 480, 580 Fixing member
81, 181, 281, 381, 581 First attachment portion
   81a Stepped portion
82, 182, 282, 382, 582 Second attachment portion
   82a Stepped portion
83, 183, 283, 383, 583 Connecting portion
84, 184 Hook portion
85, 185, 285, 385 Through hole
86, 186, 286, 386 Reinforcement portion
   86a First reinforcement portion
   86b Second reinforcement portion
87 Attachment bolt
   87a First attachment bolt
   87b Second attachment bolt
88 Attachment nut
F Conveyance floor
F1 Accommodation recess

1. A fixing member for a conveyance seat, which is attached to a back surface of a seat cushion of the conveyance seat and which is used for attaching an object to the conveyance seat, the fixing member comprising:
a first attachment portion and a second attachment portion provided spaced apart from each other along the back surface of the seat cushion, and attached to the back surface of the seat cushion; and
a connecting portion connecting the first attachment portion and the second attachment portion,
wherein a plurality of through holes for fixing the object are formed in the connecting portion.

2. The fixing member for a conveyance seat according to claim 1, further comprising:
a hook portion for hooking an object to be hooked,
wherein the hook portion is disposed between the first attachment portion and the second attachment portion.

3. The fixing member for a conveyance seat according to claim 2,
wherein a plurality of the hook portions are provided on the connecting portion, and are disposed spaced apart from each other in an extending direction of the connecting portion.

4. The fixing member for a conveyance seat according to claim 3,
wherein the through holes are provided to penetrate through the connecting portion, and
the fixing member includes a reinforcement portion provided in a portion of the connecting portion, in which the through holes are formed, and extending across the connecting portion.

5. The fixing member for a conveyance seat according to claim 4,
wherein the hook portions are disposed at positions not overlapping the reinforcement portion in the extending direction of the connecting portion.

6. The fixing member for a conveyance seat according to claim 4,
wherein each of the hook portion and the reinforcement portion extends in a direction different from the extending direction of the connecting portion, and extends in the same direction in the connecting portion.

7. The fixing member for a conveyance seat according to claim 4,
wherein the reinforcement portion is disposed at a position interposed between the plurality of hook portions in the extending direction of the connecting portion.

8. The fixing member for a conveyance seat according to claim 2,
wherein the connecting portion is provided at a predetermined spacing from the back surface of the seat cushion, and
the hook portion is provided on the connecting portion, and is disposed at a position separated from the back surface of the seat cushion.

9. The fixing member for a conveyance seat according to claim 8,
wherein the connecting portion is disposed at a position where the connecting portion linearly connects the first attachment portion and the second attachment portion.

10. The fixing member for a conveyance seat according to claim 9,
wherein the through holes are provided to penetrate through the connecting portion,
the fixing member includes a reinforcement portion provided in a portion of the connecting portion, in which the through holes are formed, and extending across the connecting portion, and
the reinforcement portion is provided in the connecting portion, and is disposed at a position separated from the back surface of the seat cushion.

11. The fixing member for a conveyance seat according to claim 9,
wherein a central portion in an extending direction of the connecting portion is disposed at a position separated farthest from the back surface of the seat cushion, and
the hook portion is disposed on the central portion of the connecting portion.

12. The fixing member for a conveyance seat according to claim 8, further comprising:
a first reinforcement portion and a second reinforcement portion formed in a portion of the connecting portion, in which the through holes are formed, and extending across the connecting portion,
wherein the first reinforcement portion is disposed between a central portion of the connecting portion and the first attachment portion, and
the second reinforcement portion is disposed between the central portion of the connecting portion and the second attachment portion.

13. A conveyance seat, comprising:
a seat cushion,
wherein the conveyance seat is switchable between a normal state for an occupant to be seated and a moved state where the seat cushion is moved from the normal state,
the seat cushion is provided such that a back surface of the seat cushion is exposed when the conveyance seat is in the moved state,
a fixing member for attaching an object to the conveyance seat is attached to the back surface of the seat cushion,
the fixing member includes a first attachment portion and a second attachment portion provided spaced apart from each other along the back surface of the seat cushion, and attached to the back surface of the seat cushion, and a connecting portion connecting the first attachment portion and the second attachment portion, and
a plurality of through holes for fixing the object are formed in the connecting portion.

14. The conveyance seat according to claim 13,
wherein the fixing member has a color different from a color of a portion of the back surface of the conveyance seat, the fixing member being attached to the portion.

15. The conveyance seat according to claim 13, further comprising:
a support leg attached between the seat cushion and a conveyance floor, and supporting the seat cushion,
wherein at least a part of the fixing member is disposed at a position overlapping the support leg in a seat width direction.

16. The conveyance seat according to claim 15,
wherein the fixing member includes a hook portion for hooking an object to be hooked, and
at least a part of the hook portion is disposed at a position overlapping the support leg in the seat width direction of the conveyance seat.

17. The conveyance seat according to claim 15,
wherein the fixing member includes a first attachment bolt for attaching the first attachment portion to a first attached portion provided in the back surface of the seat cushion, and a second attachment bolt for attaching the second attachment portion to a second attached portion provided in the back surface of the seat cushion,
the first attachment bolt is disposed inside the second attachment bolt and is disposed at a position overlapping the support leg, in the seat width direction of the conveyance seat, and
the second attachment bolt is disposed at a position not overlapping the support leg in the seat width direction of the conveyance seat.

18. The conveyance seat according to claim 13, further comprising:
a support leg attached between the seat cushion and a conveyance floor, and supporting the seat cushion,
wherein the connecting portion is provided at a predetermined spacing from the back surface of the seat cushion,
a central portion in an extending direction of the connecting portion is disposed at a position separated farthest from the back surface of the seat cushion, and
the central portion of the connecting portion and the support leg are disposed at the same position in the seat width direction.

19. A method for manufacturing a conveyance seat including a seat cushion and a fixing member provided on a back surface of the seat cushion and used for attaching an object to the conveyance seat, the method comprising:
preparing the fixing member including a first attachment portion, a second attachment portion, and a connecting portion connecting the first attachment portion and the second attachment portion;
attaching the first attachment portion to the back surface of the seat cushion; and
attaching the second attachment portion to the back surface of the seat cushion at a position spaced apart from the first attachment portion, and disposing a plurality of through holes formed in the connecting portion, to be spaced apart from the back surface of the seat cushion.
